(19) United States
(12) Patent Application Publication
(10) Pub. No.: US 2011/0025220 A1
(43) Pub. Date: Feb. 3, 2011

(54) HIGH EFFICIENCY GAS FILLED LAMP

(75) Inventor: Avraham EMANUEL, Johannesburg (ZA)

Correspondence Address: MARTIN D. MOYNIHAN d/b/a PRTSI, INC., P.O. BOX 16446, ARLINGTON, VA, 22215, US

(73) Assignee: Yehi-Or Light Creation Ltd., RaAnana (IL)

(21) Appl. No.: 12/861,854

(22) Filed: Aug. 24, 2010

Related U.S. Application Data
(63) Continuation-in-part of application No. PCT/IB2009/050747, filed on Aug. 25, 2009.

(30) Foreign Application Priority Data
Feb. 25, 2008 (ZA) 2008/01775

(51) Int. Cl. H01J 1/50; H05B 41/00; H05B 41/36

(52) U.S. Cl. 315/246; 313/161; 315/363

(57) ABSTRACT

The invention relates to a gas filled lamp and to a method of operating the same, the gas filled lamp including a tube filled with a gas or combination of gases, the tube comprising an anode; and a cathode spaced apart from the anode wherein an electric field can be applied across the anode and the cathode so as to cause an electron to move from the cathode to the anode. The gas filled lamp further includes magnetising means to provide a magnetic field across the tube, the direction of the magnetic field being substantially perpendicular to the direction of the electric field, wherein the ratio between the electric and magnetic fields is substantially predetermined depending upon the gas or combination of gases within the tube.

### RELATED APPLICATIONS

This application is a continuation-in-part of PCT Patent Application No. PCT/IB2009/050747 having International filing date of Feb. 25, 2009, which claims the benefit of South Africa Patent Application No. 2008/01775 filed on Feb. 25, 2008. The contents of the above Applications are all incorporated herein by reference.

### BACKGROUND OF THE INVENTION

THIS invention relates to a high efficiency gas filled lamp.

Conventional discharge lamps (whether fluorescent or other types) typically comprise a glass tube filled with a suitable gas (or gases), with electrons being accelerated in such a way that part of their kinetic energy may be transferred to the atoms (or molecules) of the gas/es, thereby exciting electrons in them to suitable energy levels so that when “falling” to their basis levels they create photons. This process is well known in quantum physics.

However, a major downside with such conventional lamps is their relatively low efficiencies, which may typically be around 8%-12%. As a result, a relatively high amount of energy is converted and dissipated as heat energy, which is clearly not ideal.

It is therefore an aim of the present invention to provide a gas filled based lamp that addresses the above shortcomings of conventional discharge and other types of lamps.

### SUMMARY OF THE INVENTION

According to a first aspect of the invention there is provided a gas filled lamp comprising:
a tube filled with a gas or combination of gases, the tube comprising:
   an anode; and
   a cathode spaced apart from the anode wherein an electric field can be applied across the anode and the cathode so as to cause an electron to move from the cathode to the anode; and
magnetising means to provide a magnetic field across the tube, the direction of the magnetic field being substantially perpendicular to the direction of the electric field, wherein the ratio between the electric and magnetic fields is substantially predetermined depending upon the gas or combination of gases within the tube so that an electron emitted from the cathode, subject to the electric and magnetic fields, can continuously gain kinetic energy from the electric field until it reaches a maximum with the kinetic energy and due to the magnetic field, reaching a minimum, this cycle repeating periodically until the electron strikes an atom of the gas/es and in some of those strikes the electron delivers to the atom an amount of energy, with the resultant excitation of electrons in the atom of the gas/es causing light.

The ratio between the electric and magnetic fields may be chosen such that the maximum kinetic energy that any free electron acquires may be between 3 eV and 18 eV.

The cathode may comprise:
a first cathode arranged at least to facilitate emission of electrons; and
a second cathode which, together with the anode, is arranged to generate the electric field between the second cathode and the anode.

The second cathode may be located outside the tube.

The magnetising means may include at least one magnet defining magnetic North and South poles.

In an example embodiment, the gas in the tube may be one or a combination of Neon, Argon, Sodium, Mercury, or the like.

The electric and magnetic fields may be substantially homogeneous fields respectively.

The magnetic field may be a bi-directional magnetic field.

The electric field may be generated by an Alternating Current (AC) voltage.

According to a second aspect of the invention there is provided a method of operating a gas filled lamp, the gas filled lamp comprising a tube filled with a gas or combination of gases, the method including:
applying an electric field across an anode and cathode of the tube so as to cause an electron to move from the cathode to the anode; and
applying a magnetic field across the tube by way of a magnetising means, wherein the magnetic field applied is substantially perpendicular to the direction of the electric field and wherein the ratio between the electric and magnetic fields is substantially predetermined depending upon the gas or combination of gases within the tube, so that an electron emitted from the cathode, subject to the electric and magnetic fields, can continuously gain kinetic energy from the electric field until it reaches a maximum with the kinetic energy and due to the magnetic field, reaching a minimum, this cycle repeating periodically until the electron strikes an atom of the gas/es and in some of those strikes the electron delivers to the atom an amount of energy, with the resultant excitation of electrons in the atom of the gas/es causing light.

The method may include determining the ratio between the electric and magnetic fields such that the maximum kinetic energy that any free electron acquires may be between 3 eV and 18 eV.

The method may include applying an Alternating Current (AC) voltage across the cathode and anode to generate the electric field.

### BRIEF DESCRIPTION OF THE DRAWINGS

FIG. 1 shows a perspective schematic view of a high efficiency gas filled lamp according to an example embodiment of the present invention;

FIG. 2 shows a representation of the movement of an electron within the gas filled lamp shown in FIG. 1, the movement being shown from left to right, when the magnetic field is towards the page;

FIG. 3 shows a graph representing the kinetic energy versus time of an electron moving through the gas filled lamp shown in FIG. 1;

FIG. 4 shows a schematic view of a portion of the lamp of FIG. 1 illustrating an imaginary surface parallel to the anode and cathode of the lamp; and

FIG. 5 shows a perspective schematic view of a portion of another example embodiment of a high efficiency gas filled lamp.

### DESCRIPTION OF PREFERRED EMBODIMENTS

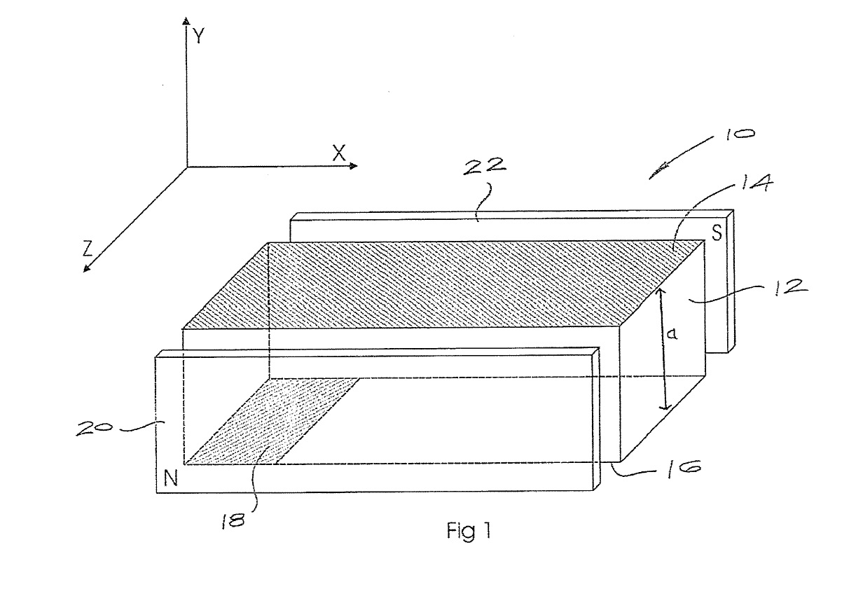

Referring first to FIG. 1, a high efficiency gas filled lamp 10 comprises a tube 12 filled with a gas or combination of gases. In example embodiments, the gas may comprise Neon, Argon, Sodium, Mercury, or any other vapour.

It will be appreciated that the tube 12 can be in different shapes and sizes.

The tube 12 may in turn comprise an anode 14 and a cathode which can be split into a first cathode 16 and a second cathode 18, of which the first cathode 16 is responsible for the emission of electrons and the second cathode 18 together with the anode 14 is responsible for creating the electric filed necessary for accelerating the electrons towards the anode 14. Both first and second cathodes 16, 18 are spaced apart from the anode 14. The second cathode 18 may be placed out of the gas filled part of the lamp construction. In other examples the first cathode 16 may be placed outside the tube 12.

The electric field may be generated by applying either a DC or AC voltage across the anode 14 and cathode 16, 18 so that there is an electric field of strength (V/a) in the y direction, where ‘a’ is the distance between the anode 14 and the cathode 16, 18.

Magnetising means, in the form of a pair of opposed magnets (or a single magnet) defining a magnetic North 20 and a magnetic South 22, provides a magnetic field across the tube 12. As can be seen in FIG. 1, the direction of the magnetic field is substantially perpendicular to the direction of the electric field, along the z direction.

The tube is preferably evacuated to low pressure. In examples, the lighting tube may have a pressure within the range of 2 Tor, 1 Tor and 0.5 Tor, in order to improve penetration of the electrons along the electron path.

In an example embodiment, the ratio between the electric and magnetic fields is substantially predetermined depending upon the gas or combination of gases within the tube 12, and other parameters, so that an electron emitted from the cathode, subject to the electric and magnetic fields, can continuously gain kinetic energy from the electric field until it reaches a maximum with the kinetic energy then being reduced to a minimum. As shown in FIG. 3, this cycle repeats periodically until the electron strikes an atom of the gas/es in which case the electron delivers to the atom an amount of energy, with the resultant excitation of electrons in the atom of the gas/es causing light. This process with the same electron carries on producing more light until the electron reaches the anode 14.

The controlling of the motion of the free electrons in the tube 12 is based on the fact that the trajectories of any charged particles in an electromagnetic environment is dependent on the directions of the electric and magnetic fields, which, in the illustrated embodiment, are perpendicular to each other, and on the ratio of the two fields. In an example embodiment, the ratio of the two fields is such that the maximum kinetic energy that any free electron may acquire (in accordance with FIG. 3) may be between 3 eV and 18 eV.

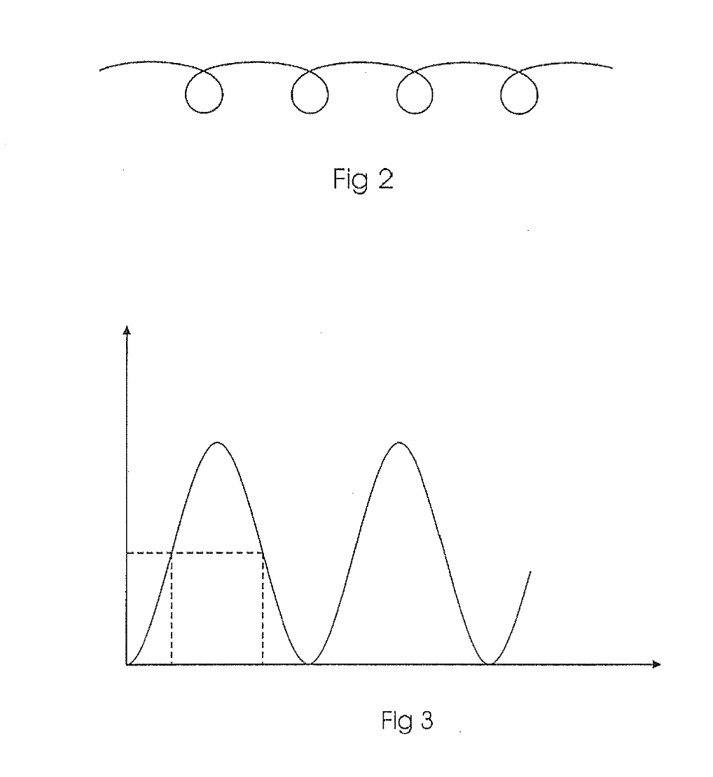

The controlling process is based on the fact that the magnetic field (which has to be applied at a very defined intensity) does not allow the emitted electrons to proceed with their motion in a straight line towards the anode, but their trajectories are bent as shown in FIG. 2, being periodic in energy, with a displacement in the x direction.

As indicated in FIG. 2, the electron may move primarily along the x direction, but in the y direction it may not exceed a certain length Ay. If the maximum energy of the electron is about 3 eV, an electron may not reach the anode 14 unless it excites about V/3 electrons and when reaching the anode 14 it may not impinge on it, but with only an energy of the order of 3 eV so that sputtering is avoided, thereby prolonging the tube's life.

Thus, when striking the atom, the electron slows down and takes a different course than the one it would have taken if it did not strike the atom. If the kinetic energy of the electron is less than the minimal excitation energy of the gas atoms, this process will be repeated. If the voltage between the anode 14 and cathode 16, 18 is chosen to be 300 V and the excitation energy in order to get photons in the visible range is 3 eV, it is in principle possible to create 100 photons by one emitted electron from the cathode 18.

It is noted that drift of electrons in the direction of the magnetic field vector may occur when the applied magnetic field direction is constant (i.e. mono-directional). As this drift is not desirable, (causing electron density losses), a bi-directional field may be applied in order to compensate for the drift.

The electric field may also be alternating (i.e. not necessarily DC), this can also compensate for undesired drift towards the anode 14 which does not contribute to the desired excitation of the gas atoms (or molecules) which in turn creates light.

The essence of this invention is the limiting of the energies of the free electrons (to a certain maximum) so that no electrons may reach the anode 14 unless they deliver (whole or in part) their energies towards the excitation of (the gas/es) atoms or molecules within the tube 12, which means that no energy is drawn from the electric field unless visible light is created first. This is in contrast to the conventional discharge lamps, in which, the motion of the free electrons is random (i.e. without any limiting mechanism), thereby either exciting atoms randomly, at various levels of excitation (i.e. either visible or ultra-violet light) or impinging on the anode 14 at relatively high energies without causing any excitation of atoms, therefore, creating just heat with no light which is the very reason for their low efficiency hereinbefore mentioned.

It will be appreciated that the physical shape of the lamp 10 need not necessarily be parallelepiped, as illustrated, but may take any shape as long as the above mentioned principle of limiting the free electrons energies (between the above limits) is satisfied.

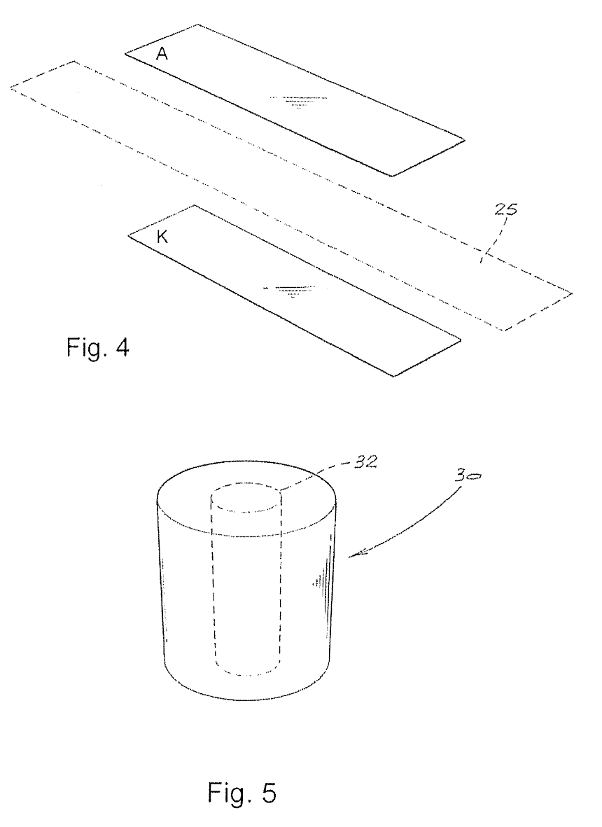

In an example embodiment, the electric field and the magnetic fields are substantially homogeneous. Referring to FIG. 4, where the lamp 10 is parallelepiped, the electric field across any straight imaginary surface 25 parallel the electrodes is substantially uniform. The magnetic field, which is perpendicular to the electric field, is also substantially uniform.

Referring to FIG. 5 where a cylindrical lamp is indicated by reference numeral 30. In this particular illustrated example embodiment, the electric field is substantially homogeneous across (i.e. perpendicular to) any surface forming an imaginary cylinder 32 within the cylindrical lamp 30. It follows that the magnetic field which is perpendicular to the electric field, and therefore along the imaginary cylinder 32 surface, is also substantially homogenous.

It will be appreciated that the homogeneity and perpendicularity of both the electric and magnetic fields is of vital importance to the invention.

Also, it will be noted that a main feature of the present invention is that the anode and the field cathode extend all along the motion (trajectories) of the electrons within the tube 12.

The higher efficiency of the proposed lamp means less heat losses and thus a saving in electrical energy.

1.-12. (canceled)

13. A lighting tube having a first and a second end and comprising:
a field anode and a field cathode arranged lengthwise along said tube to provide an electric field;
magnets arranged lengthwise along said tube to provide a magnetic field, said magnets being arranged such that said magnetic field is substantially perpendicular to said magnetic field;
said electric and magnetic fields together providing an electron path lengthwise along said tube.

14. A lighting tube having a first end and a second end, and a longitudinal length therebetween, and comprising an electron path along said longitudinal length set up for electrons emitted at said first end to travel from said first end to said second end.

15. A method of providing lighting comprising:
in a confined space having a longitudinal length:
providing an electrical field;
providing a magnetic field orthogonally to said electrical field to provide a path for electrons;
selecting values of said fields to limit electron kinetic energy of electrons travelling in said path to excitation energies of photons of a desired wavelength, thereby to provide efficient conversion of electron collisions to photons; and
providing a source of electrons for said path.

16. The method of claim 15, wherein said values are in the order of magnitude of 300 Gauss for said magnetic field and 200V/cm for said electrical field.

17. The method of claim 15, wherein said values are 300 Gauss for said magnetic field and 200V/cm for said electrical field.

18. A gas filled lamp comprising:
a tube filled with a gas or combination of gases, the tube comprising:
an anode extending substantially along the length of the tube; and
a cathode spaced apart from the anode, and extending substantially along the length of the tube, wherein an electric field can be applied between the anode and the cathode so as to cause an electron to move from the cathode in the direction of the anode; and
at least one magnet to provide a magnetic field along the length of the tube, the direction of the magnetic field being substantially perpendicular to the direction of the electric field, such that relatively perpendicular magnetic and electrical fields provide a controlled energy electron path along the length of the tube.

19. A gas filled lamp according to claim 18, wherein the ratio between the electric and magnetic fields is substantially predetermined depending upon the gas or combination of gases within the tube.

20. A gas filled lamp according to claim 19, wherein the ratio is such that an electron emitted from the cathode, subject to the electric and magnetic fields, can continuously gain kinetic energy from the electric field until it reaches a maximum level of kinetic energy and subsequently falls to a minimum due to the magnetic field, in a cycle repeating periodically until the electron strikes an atom of the gas/es such that in some of those strikes the electron delivers to the atom an amount of energy, the amount of energy being able to bring about a resultant excitation of electrons in the atom of the gas/es that causes light.

21. A gas filled lamp as claimed in claim 19, wherein the ratio between the electric and magnetic fields is chosen such that the maximum kinetic energy that any free electron acquires is between 3 eV and 18 eV.

22. A gas filled lamp as claimed in claim 13, wherein the cathode comprises:
a first cathode part arranged at least to facilitate emission of electrons; and
a second cathode part which, together with the anode, is arranged to generate the electric field between the second cathode and the anode.

23. A gas filled lamp as claimed in claim 22, wherein the second cathode is located outside the tube.

24. A gas filled lamp as claimed in claim 13, wherein the magnetising means includes at least one magnet defining magnetic North and South poles.

25. A gas filled lamp as claimed in claim 13, wherein gas in the tube is one or a combination of Neon, Argon, Sodium, Mercury, or the like.

26. A gas filled lamp as claimed in claim 13, wherein the electric and magnetic fields are substantially homogeneous fields respectively.

27. A gas filled lamp as claimed in claim 13, wherein the magnetic field is a bi-directional magnetic field.

28. A gas filled lamp as claimed in claim 13, wherein the electric field is generated by an Alternating Current (AC) voltage.

29. A method of operating a gas filled lamp, the gas filled lamp comprising a tube filled with a gas or combination of gases, the method including
applying an electric field across an anode and a cathode set out along a length of the tube so as to cause an electron to move from the cathode towards the anode; and
applying a magnetic field across the length of the tube by way of a magnetizing means, wherein the magnetic field applied is substantially perpendicular to the direction of the electric field such that relatively perpendicular magnetic and electrical fields provide a controlled energy electron path along the length of the tube.

30. The method of claim 29, wherein the ratio between the electric and magnetic fields is substantially predetermined depending upon the gas or combination of gases within the tube.

31. The method of claim 30, wherein an electron emitted from the cathode, subject to the electric and magnetic fields, can continuously gain kinetic energy from the electric field until it reaches a maximum of the kinetic energy and then, due to influence of the magnetic field, falls to a minimum, this cycle repeating periodically, during which cycle the electron may strike an atom of the gas/es and in some of those strikes the electron delivers to the atom an amount of energy, the amount being such that the resultant excitation of electrons in the atom of the gas/es causes light.

32. A method as claimed in claim 29, wherein the method includes determining the ratio between the electric and magnetic fields such that the maximum kinetic energy that any free electron acquires is between 3 eV and 18 eV.

33. A method as claimed in claim 29, wherein the method includes applying an Alternating Current (AC) voltage across the cathode and anode to generate the electric field.
